(19) United States
(12) Patent Application Publication
(10) Pub. No.: US 2025/0378132 A1
(43) Pub. Date: Dec. 11, 2025

(54) SYSTEMS AND METHODS INCORPORATING FAST LIPSCHITZ CONSTANT ESTIMATION FOR NEURAL NETWORKS

(71) Applicant: Purdue Research Foundation, West Lafayette, IN (US)

(72) Inventors: Sivaranjani Seetharaman, West Lafayette, IN (US); Yuezhu Xu, Lafayette, IN (US)

(73) Assignee: Purdue Research Foundation, West Lafayette, IN (US)

(21) Appl. No.: 19/223,596

(22) Filed: May 30, 2025

Related U.S. Application Data
(60) Provisional application No. 63/656,415, filed on Jun. 5, 2024.

(51) Int. Cl. G06F 17/13; G06N 3/0499; G06N 3/08

(52) U.S. Cl. CPC G06F 17/13; G06N 3/0499; G06N 3/08

(57) ABSTRACT

A compositional approach to estimating Lipschitz constants for deep feed-forward neural networks is disclosed herein. We first obtain an exact decomposition of the large matrix verification problem into smaller sub-problems. Then, leveraging the underlying cascade structure of the network, we develop two algorithms. The first algorithm explores the geometric features of the problem and enables us to provide Lipschitz estimates that are comparable to existing methods by solving small semidefinite programs (SDPs) that are only as large as the size of each layer. The second algorithm relaxes these sub-problems and provides a closed-form solution to each sub-problem for extremely fast estimation, altogether eliminating the need to solve SDPs. The two algorithms represent different levels of trade-offs between efficiency and accuracy.

This application claims the benefit of priority of U.S. provisional application Ser. No. 63/556,415, filed on Jun. 5, 2024, the disclosure of which is herein incorporated by reference in its entirety.

### GOVERNMENT LICENSE RIGHTS

This invention was made with government support under FA9550-23-0492 awarded by the Air Force Office of Scientific Research. The government has certain rights in the invention.

### FIELD

The systems and methods disclosed in this document relate to neural networks and, more particularly, to fast Lipschitz constant estimation for systems incorporating a neural network.

### BACKGROUND

Unless otherwise indicated herein, the materials described in this section are not admitted to be the prior art by inclusion in this section.

The Lipschitz constant, which quantifies how a neural network's output varies in response to changes in its inputs, is a crucial measure in providing robustness certificates on downstream tasks such as ensuring resilience against adversarial attacks, stability of learning-based models or systems with neural network controllers, enhancing generalizability, improving gradient-based optimization methods and controlling the rate of learning. The problem of calculating the exact Lipschitz constant is NP-hard. Therefore, efforts have been made to estimate tight upper bounds for the Lipschitz constant of feed-forward neural networks and other architectures such as convolutional neural networks.

Typical approaches include formulating a polynomial optimization problem or bounding the Lipschitz constant via quadratic constraints and semidefinite programming (SDP), which in turn requires solving a large-scale matrix verification problem whose computational complexity grows significantly with both the depth and width of the network. These approaches have also motivated the development of methods to design neural networks with certifiable robustness guarantees.

The simplest way to estimate the Lipschitz constant is to provide a naive upper bound using the product of induced weight norms, which is rather conservative. Another approach is to utilize automatic differentiation to approximate a bound, which is not a strict upper bound, although it is often so in practice. Additionally, compositions of non-expansive averaged operators and affine operators, Clarke Jacobian-based approaches, and other methods focusing on local Lipschitz constants have also been studied.

Recently, optimization-based approaches such as sparse polynomial optimization and SDP methods, such as the canonical LipSDP framework, have been successful in providing tighter Lipschitz bounds. SDP-based methods specifically exploit the slope-restrictedness of the activation functions to cast the problem of estimating a Lipschitz constant as a linear matrix verification problem. However, the computational cost of such methods explodes as the number of layers increases. A common strategy to address this is to ignore some coupling constraints among the neurons to reduce the number of decision variables, yielding a more scalable algorithm at the expense of estimation accuracy.

Thus, what is needed is a method for estimating a Lipschitz constant that is both accurate and computationally low-cost.

### SUMMARY

A method for characterizing a robustness of a neural network is disclosed herein. The method comprises estimating, with a processor, a Lipschitz constant for the neural network. The Lipschitz constant is estimated by forming a first matrix inequality for the neural network. The Lipschitz constant is further estimated by decomposing the first matrix inequality into a plurality of second matrix inequalities. The Lipschitz constant is further estimated by determining a plurality of first matrices based on the plurality of second matrix inequalities. The Lipschitz constant is further estimated by estimating the Lipschitz constant based on the plurality of first matrices.

A method for certifying a robustness of a neural network is also disclosed. The method comprises training, with a processor, the neural network using a plurality of training data. The method further comprises evaluating, with the processor, the neural network by estimating a Lipschitz constant for the neural network. The Lipschitz constant is estimated by forming a first matrix inequality for the neural network. The Lipschitz constant is further estimated by decomposing the first matrix inequality into a plurality of second matrix inequalities. The Lipschitz constant is further estimated by determining a plurality of first matrices based on the plurality of second matrix inequalities. The Lipschitz constant is further estimated by estimating the Lipschitz constant based on the plurality of first matrices. The method further comprises generating, with the processor, a robustness certificate for the neural network in response to the Lipschitz constant satisfying a defined condition.

A method for operating a system that incorporates a neural network is also disclosed. The method comprises receiving, with a processor, a plurality of input data over time. The method further comprises updating, with the processor, the neural network over time based on the plurality of input data using an online training process. The method further comprises evaluating, with the processor, the neural network over time by periodically estimating a Lipschitz constant for the neural network. The Lipschitz constant is estimated by forming a first matrix inequality for the neural network. The Lipschitz constant is further estimated by decomposing the first matrix inequality into a plurality of second matrix inequalities. The Lipschitz constant is further estimated by determining a plurality of first matrices based on the plurality of second matrix inequalities. The Lipschitz constant is further estimated by estimating the Lipschitz constant based on the plurality of first matrices. The method further comprises operating, with the processor, in response to the Lipschitz constant satisfying a defined condition, the system to perform an operation based on an output from the neural network.

### BRIEF DESCRIPTION OF THE DRAWINGS

The foregoing aspects and other features of the systems and methods are explained in the following description, taken in connection with the accompanying drawings.

FIG. 1 shows an exemplary embodiment of a computing device that can be used for training and evaluating a feed-forward neural network.

FIG. 2 shows a flow diagram for a method for estimating the Lipschitz constant for a feed-forward neural network.

FIG. 3 shows pseudocode for an exemplary implementation of an ECLipsE algorithm and an ECLipsE-Fast algorithm.

FIG. 4A shows a Geometric Analysis of the ECLipsE algorithm.

FIG. 4B shows a comparison between the ECLipsE-Fast algorithm and the ECLipsE algorithm in the case where cᵢ>1.

FIG. 5A shows a performance of the ECLipsE-Fast algorithm and the ECLipsE algorithm for a randomly generated network with increasing network depth, with respect to baselines.

FIG. 5B shows a performance of the ECLipsE-Fast algorithm and the ECLipsE algorithm for randomly generated networks with increasing network width, with respect to baselines.

FIG. 5C shows computation time vs estimation accuracy for the ECLipsE algorithm, the ECLipsE-Fast algorithm, and LipSDP splitting with different sub-network sizes.

FIG. 5D shows a performance of the ECLipsE-Fast algorithm and the ECLipsE algorithm for a 3-layer network trained on MNIST, with respect to baselines for an increasing number of neurons.

FIG. 6 shows a flow diagram for a method for certifying the robustness of a feed-forward neural network.

FIG. 7 shows an exemplary embodiment of the autonomous system that leverages a feed-forward neural network to perform one or more tasks.

FIG. 8 shows a flow diagram for a method for operating an autonomous system.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

### Overview

A compositional approach to estimating Lipschitz constants for deep feed-forward neural networks is disclosed herein. We first obtain an exact decomposition of the large matrix verification problem into smaller sub-problems. Then, leveraging the underlying cascade structure of the network, we develop two algorithms. The first algorithm explores the geometric features of the problem and enables us to provide Lipschitz estimates that are comparable to existing methods by solving small semidefinite programs (SDPs) that are only as large as the size of each layer. The second algorithm relaxes these sub-problems and provides a closed-form solution to each sub-problem for extremely fast estimation, altogether eliminating the need to solve SDPs. The two algorithms represent different levels of trade-offs between efficiency and accuracy. In summary, our approach considerably advances the scalability and efficiency of certifying neural network robustness, making it particularly attractive for online learning tasks.

The methods disclosed herein begin with the large matrix verification SDP for Lipschitz constant estimation under the well-known framework LipSDP. To avoid handling a large matrix inequality, we employ a sequential Cholesky decomposition technique to obtain an exact decomposition of the large matrix verification problem into a series of smaller, more manageable sub-problems that are only as large as the size of the weight matrix in each layer. Then, observing the cascade structure of the neural network, we leverage (i) an ECLipsE algorithm, which characterizes the geometric features of the optimization problem and enables us to provide an accurate Lipschitz estimate and (ii) an ECLipsE-Fast algorithm, which further relaxes the sub-problems, and yields a closed-form solution for each sub-problem that altogether eliminates the need to solve any SDPs, resulting in extremely fast implementations.

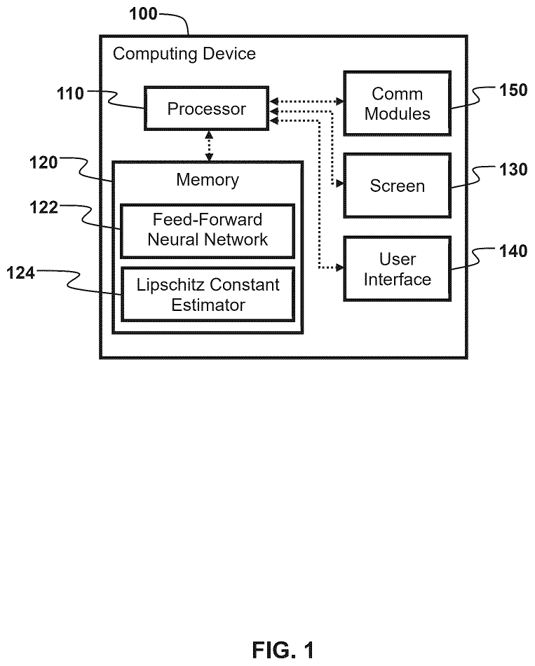

FIG. 1 shows an exemplary embodiment of a computing device 100 that can be used for training and evaluating a feed-forward neural network. The computing device 100 comprises a processor 110, a memory 120, a display screen 130, a user interface 140, and at least one network communications module 150. It will be appreciated that the illustrated embodiment of the computing device 100 is only one exemplary embodiment and is merely representative of any of various manners or configurations of a server, a desktop computer, a laptop computer, or any other computing devices that are operative in the manner set forth herein.

The processor 110 is configured to execute instructions to operate the computing device 100 to enable the features, functionality, characteristics, and/or the like as described herein. To this end, the processor 110 is operably connected to the memory 120, the display screen 130, and the network communications module 150. The processor 110 generally comprises one or more processors that may operate in parallel or otherwise in concert with one another. It will be recognized by those of ordinary skill in the art that a “processor” includes any hardware system, hardware mechanism, or hardware component that processes data, signals, or other information. Accordingly, the processor 110 may include a system with a central processing unit, graphics processing units, multiple processing units, dedicated circuitry for achieving functionality, programmable logic, or other processing systems.

The memory 120 is configured to store data and program instructions that, when executed by the processor 110, enable the computing device 100 to perform various operations described herein. The memory 120 may be of any type of device capable of storing information accessible by the processor 110, such as a memory card, ROM, RAM, hard drives, discs, flash memory, or any of various other computer-readable medium serving as data storage devices, as will be recognized by those of ordinary skill in the art.

The display screen 130 may comprise any of various known types of displays, such as LCD or OLED screens, configured to display graphical user interfaces. The user interface 140 may include a variety of interfaces for operating the computing device 100, such as buttons, switches, a keyboard or other keypad, speakers, and a microphone. Alternatively, or in addition, the display screen 130 may comprise a touch screen configured to receive touch inputs from a user.

The network communications module 150 may comprise one or more transceivers, modems, processors, memories, oscillators, antennas, or other hardware conventionally included in a communications module to enable communications with various other devices. Particularly, the network communications module 150 generally includes an Ethernet adaptor or a Wi-Fi® module configured to enable communication with a wired or wireless network and/or router (not shown) configured to enable communication with various other devices. Additionally, the network communications module 150 may include a Bluetooth® module (not shown), as well as one or more cellular modems configured to communicate with wireless telephony networks.

In at least some embodiments, the memory 120 stores program instructions of a feed-forward neural network 122 that, once trained, is configured to process input data to generate one or more outputs. Additionally, in at least some embodiments, the memory 120 stores program instructions of a Lipschitz constant estimator 124 that is executed to estimate the Lipschitz constant for the feed-forward neural network 122 after it has been trained, retrained, or updated.

### Methods for Estimating a Lipschitz Constant for a Feed-Forward Neural Network

A variety of methods, operations, and processes are described below for operating the computing device 100 to estimate the Lipschitz constant for a feed-forward neural network 122 after it has been trained, retrained, or updated. In these descriptions, statements that a method, processor, and/or system is performing some task or function refers to a controller or processor (e.g., the processor 110 of the computing device 100) executing programmed instructions (e.g., the Lipschitz constant estimator 124) stored in non-transitory computer readable storage media (e.g., the memory 120 of the computing device 100) operatively connected to the controller or processor to manipulate data or to operate one or more components in the computing device 100 to perform the task or function. Additionally, the steps of the methods may be performed in any feasible chronological order, regardless of the order shown in the figures or the order in which the steps are described.

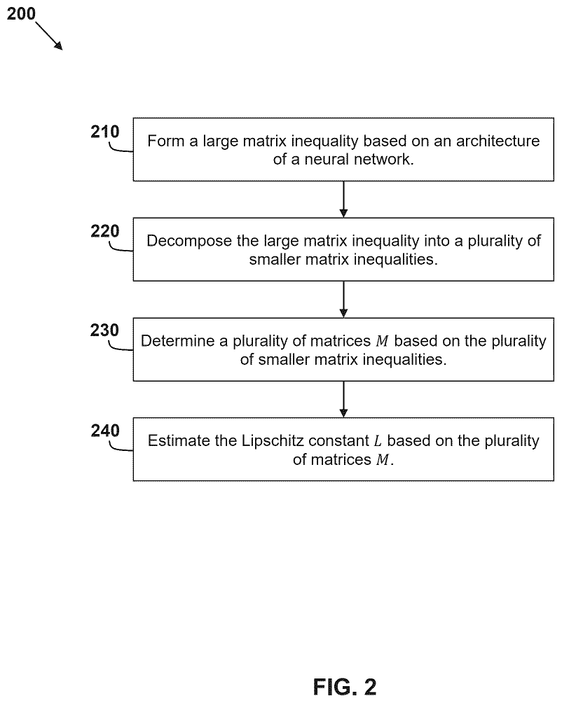

FIG. 2 shows a flow diagram for a method 200 for estimating the Lipschitz constant for a feed-forward neural network. The method 200 advantageously enables the Lipschitz constant for a feed-forward neural network to be estimated very quickly and with high accuracy. Thus, it will be appreciated that the method 200 is advantageous for applications in which real-time robustness certification of a feed-forward neural network is necessary or desirable, such as in safety-critical systems (e.g., autonomous driving or medical diagnostics).

The method 200 begins with forming a large matrix inequality based on an architecture of a neural network (block 210). Particularly, the processor 110 of the computing device 100 is configured to form a large matrix inequality for the feed-forward neural network 122. The processor 110 is configured to form the large matrix inequality based on the layer-by-layer architecture of the feed-forward neural network 122. The process for forming the large matrix inequality is described in further detail below.

Notation. We define [symbol] _{N}={1, . . . , N}, where N is a natural number excluding zero. A symmetric positive-definite matrix P∈ [symbol] ^{n×n} is represented as P>0 (and as P≥0, if it is positive semi-definite). We denote the largest singular value or the spectral norm of matrix A by σₘₐₓ(A). The set of positive semi-definite diagonal matrices is written as [symbol] ₊.

Problem Formulation. The feed-forward neural network 122 has a sequence of l layers with input z∈ [symbol] ^{d}^{₀} and output y∈ [symbol] ^{d}^{ₗ} defined as y=ƒ(z). The function ƒ is recursively formulated with layers Lᵢ, i∈ [symbol] , defined as

$${L}_{i} : {z}^{( i )} = ϕ ( {v}^{( i )} ) ∀ i ∈ , {L}_{l} : y = f ( z ) = {z}^{( l )} = {v}^{( l )} , {z}^{( 0 )} = z \qquad ( 1 )$$

where v⁽ⁱ⁾=Wᵢz⁽ⁱ⁻¹⁾+bᵢ with Wᵢ and bᵢ representing the weight and bias for the layer Lᵢ respectively, and ϕ: [symbol] ^{d}^{ᵢ}→ [symbol] ^{d}^{ᵢ} is a nonlinear activation function that acts element-wise on its argument. The layers Lᵢ comprise a sequence of hidden neural network layers, and the last layer Lᵢ is the output layer. We denote the number of neurons in the layer Lᵢ by dᵢ, i∈ [symbol] ₗ.

Definition 1. A function ƒ: [symbol] ^{d}^{₀}→ [symbol] ^{d}^{ₗ} is Lipschitz continuous on [symbol] ∈⊆ [symbol] ^{d}^{₀} if there exists a constant L>0 such that ∥ƒ(z₁)−ƒ(z₂)∥₂≤L∥z₁−z₂∥₂, ∀z₁, z₂∈ [symbol] . The smallest positive L satisfying this inequality is termed the Lipschitz constant of the function ƒ.

Without loss of generality, we assume Wᵢ≠0, i∈Zₗ, as any weights being 0 will lead to the trivial case where the output corresponding to any input will remain the same after that layer. Our goal is to provide a scalable approach to give an efficient and accurate upper bound for the Lipschitz constant L>0.

Preliminaries. We begin with a slope-restrictedness property satisfied by most activation functions, which is typically leveraged to derive SDPs for Lipschitz certificates.

Assumption 1 (Slope-restrictedness). For the neural network defined in equation (1), the activation function ϕ is slope-restricted in [α, β], α<β in the sense that ∀v₁, v₂∈ [symbol] ⁿ, we have α(v₁−v₂)≤ϕ(v₁)−ϕ(v₂)≤β(v₁−v₂) element-wise. Consequently, we have that for ∀79 ∈ [symbol] ₊,

$${[ \begin{matrix}{v}_{1} - {v}_{2} \\ ϕ ( {v}_{1} ) - ϕ ( {v}_{2} )\end{matrix} ]}^{T} [ \begin{matrix}p Λ & - m Λ \\ - m Λ & Λ\end{matrix} ] [ \begin{matrix}{v}_{1} - {v}_{2} \\ ϕ ( {v}_{1} ) - ϕ ( {v}_{2} )\end{matrix} ] \leq 0 , \qquad ( 2 )$$

$$p = α β , m = α + β / 2$$

Now, we can obtain an upper bound for the Lipschitz constant as follows. This result is equivalent to the well-known LipSDP framework, described in the publication “Efficient and accurate estimation of lipschitz constants for deep neural networks” by the authors M. Fazlyab, A. Robey, H. Hassani, M. Morari, and G. Pappas, in Advances in Neural Information Processing Systems, vol. 32 (2019).

Theorem 1 (LipSDP). For the feed-forward neural network of equation (1) satisfying Assumption 1, if there exists F>0 and positive diagonal matrices Λᵢ∈ [symbol] ₊, i∈

$${ℤ}_{l - 1} such that with p = αβ and m = \frac{α + β}{2} ,$$

$$[ \begin{matrix}I + {pW}_{1}^{T} {Λ}_{1} {W}_{1} & - {mW}_{1}^{T} {Λ}_{1} & 0 & … & 0 \\ - m {Λ}_{1} {W}_{1} & {Λ}_{1} + p {W}_{2}^{T} {Λ}_{2} {W}_{2} & - m {W}_{2}^{T} {Λ}_{2} & … & 0 \\ 0 & - m {Λ}_{2} {W}_{2} & {Λ}_{2} + p {W}_{3}^{T} {Λ}_{3} {W}_{3} & … & 0 \\ & & ⋮ & & \\ 0 & … & - m {Λ}_{l - 2} {W}_{l - 2} & {Λ}_{l - 2} + p {W}_{l - 1}^{T} {Λ}_{l - 1} {W}_{l - 1} & - m {W}_{l - 1}^{T} {Λ}_{l - 1} \\ 0 & 0 & … & - m {Λ}_{l - 1} {W}_{l - 1} & {Λ}_{l - 1} - {FW}_{i + 1}^{T} {W}_{i + 1}\end{matrix} ] > 0 \qquad ( 3 )$$

$${then {‖ {z}_{2}^{( l )} - {z}_{1}^{( l )} ‖}_{1} \leq \sqrt{1 / F} ‖ {z}_{2}^{( 0 )} - {z}_{1}^{( 0 )} ‖}_{2} ,$$

which provides a sufficient condition for the Lipschitz constant L to be upper bounded by \vec{1/F}.

In at least some embodiments, the processor 110 is configured to form the large matrix inequality according to equation (3) of Theorem 1.

Remark 1. LipSDP provides three variants that tradeoff accuracy and efficiency, namely, LipSDP-Network, LipSDP-Neuron, and LipSDP-Layer, whose scalability increases sequentially at the expense of decreased accuracy. However, other works have provided a counter-example showing that the Lipschitz estimate from LipSDP-Network is not a strict upper bound. Thus, only LipSDP-Neuron, and LipSDP-Layer are valid. Theorem 1 here directly corresponds to LipSDP-Neuron. If all Λᵢ, i∈ [symbol] ₗ₋₁ in equation (3) are set to multiples of identity matrices, that is, λᵢI, i∈ [symbol] ₗ₋₁, then it corresponds to LipSDP-Layer.

Assumption 1 holds for all commonly used activation functions. For example, it holds with α=0, β=1, that is, p=0, m=½ for the ReLU, sigmoid, tanh, and exponential linear functions. Therefore, we focus on this case in this work.

With continued reference to FIG. 2, the method 200 continues with decomposing the large matrix inequality into a plurality of smaller matrix inequalities (block 220). Particularly, the processor 110 of the computing device 100 is configured to decompose the large matrix inequality (e.g., of equation (3)) into a plurality of smaller matrix inequalities. In one embodiment, the processor 110 is configured to decompose the large matrix inequality using a Cholesky decomposition process.

Exact Decomposition. We circumvent direct solution of the large matrix inequality in equation (3), which becomes computationally prohibitive as the feed-forward neural network 122 (e.g., of equation (1)) grows deeper. Instead, we leverage a sequential block Cholesky decomposition method, akin to the technique introduced in the publication “Sequential synthesis of distributed controllers for cascade interconnected systems” by the authors E. Agarwal, S. Sivaranjani, V. Gupta, and P. Antsaklis, in 2019 American Control Conference (ACC), pp. 5816-5821, IEEE (2019).

Theorem 2. A symmetric block tri-diagonal matrix defined as

$$[ \begin{matrix}{𝒫}_{1} & {ℛ}_{2} & 0 & … & & 0 \\ {𝒫}_{1} & {ℛ}_{2} & 0 & … & & 0 \\ {ℛ}_{2}^{𝒥} & {𝒫}_{2} & {ℛ}_{3} & … & & 0 \\ 0 & {ℛ}_{3}^{T} & {𝒫}_{2} & {ℛ}_{3} & … & 0 \\ & & ⋮ & & & \\ 0 & … & 0 & {ℛ}_{l - 1}^{T} & {𝒫}_{l - 1} & {ℛ}_{l} \\ 0 & … & & 0 & {ℛ}_{l}^{T} & {𝒫}_{l}\end{matrix} ] . \qquad ( 4 )$$

is positive definite if and only if Xᵢ>0, ∀i∈{0}∪ [symbol] ₗ₋₁, where

$${X}_{i} = \{ \begin{matrix}{𝒫}_{i} & if i = 0 \\ {𝒫}_{i} - {ℛ}_{i}^{T} {X}_{i - 1}^{- 1} {ℛ}_{i} & if i ∈ {ℤ}_{l - 1}\end{matrix} . \qquad ( 5 )$$

Theorem 3. Let Pₗ be defined as in equation (3) with p=0, m=½. Then, the Lipschitz certificate Pₗ>0 holds if and only if the following sequence of matrix inequalities is satisfied:

$${M}_{i} > 0 , ∀ i ∈ {ℤ}_{i - 2} , {M}_{i - 1} - {FW}_{i}^{T} {W}_{i} \qquad ( 6 )$$

$$where {M}_{i} = \{ \begin{matrix}I & i = 0 \\ {Λ}_{i} - \frac{1}{4} {Λ}_{i} {{W}_{i} ( {M}_{i - 1} )}_{l}^{- 1} {W}_{i}^{T} {Λ}_{i} & i ∈ {ℤ}_{l - 1}\end{matrix} . \qquad ( 7 )$$

In at least some embodiments, the processor 110 decomposes the large matrix inequality (e.g., of equation (3)) into the plurality of smaller matrix inequalities using equations (6) and (7) of Theorem 3. Particularly, Theorem 3 provides an exact decomposition of equation (3), and allows us to establish necessary and sufficient conditions through small matrix inequalities that scale with the size of the weight matrices of each layer, rather than that of the entire network.

The method 200 continues with determining a plurality of matrices Mᵢ based on the plurality of smaller matrix inequalities (block 230). Particularly, the processor 110 of the computing device 100 is configured to determine a plurality of matrices Mᵢ based on the plurality of smaller matrix inequalities (e.g., of equations (6) and (7)). Each of the plurality of matrices Mᵢ corresponds to a respective hidden neural network layer in the sequence of hidden neural network layers Lᵢ, denoted by a subscript i.

Pursuant to equation (7), the processor 110 determines the respective matrix M₀ based on an identity matrix I. The respective matrix M₀ corresponds to the sequentially first hidden neural network layer, i=0, in the sequence of hidden neural network layers Lᵢ. Conversely, the processor 110 determines each respective matrix Mᵢ (other than M₀) based on the respective matrix Mᵢ₋₁ corresponding to the sequentially previous hidden neural network layer i−1 in the sequence of hidden neural network layers Lᵢ. Thus, it should be appreciated that, in at least some embodiments, the processor 110 determines the plurality of matrices Mᵢ sequentially, layer-by-layer.

Additionally, pursuant to equation (7), the processor 110 determines the plurality of matrices Mᵢ based on a matrix in a plurality of matrices Λᵢ. Each of the plurality of matrices Λᵢ likewise corresponds to a respective hidden neural network layer in the sequence of hidden neural network layers Lᵢ, denoted by a subscript i. The processor 110 determines each respective matrix Mᵢ (other than M₀) based on the matrix Λᵢ corresponding to the same neural network layer.

To these ends, the processor 110 must determine the plurality of matrices Λᵢ. Particularly, to accurately estimate the Lipschitz constant, we need to decide on Λᵢ, i∈ [symbol] ₗ₋₁ that generate a tight upper bound at the last stage. In other words, we want

$${M}_{l - 1} - {FW}_{l}^{T} {W}_{l} > 0$$

to yield the smallest estimate for \vec{1/F}. In the following description, we provide compositional algorithms to decide the appropriate Λᵢ, i∈ [symbol] ₗ₋₁ sequentially, so that we only need to solve one small problem corresponding to each layer.

Compositional Algorithms. For the purpose of calculating the plurality of matrices Λᵢ, two fast compositional algorithms, the ECLipsE algorithm and the ECLipsE-Fast algorithm, were developed based on LipSDP-Layer and LipSDP-Neuron, respectively. Both algorithms are not only scalable and significantly faster, but also provide comparably accurate estimates for the Lipschitz constant. The theory supporting the algorithms and the geometric intuition is deliberately deferred and will be thoroughly discussed in the next section of the disclosure.

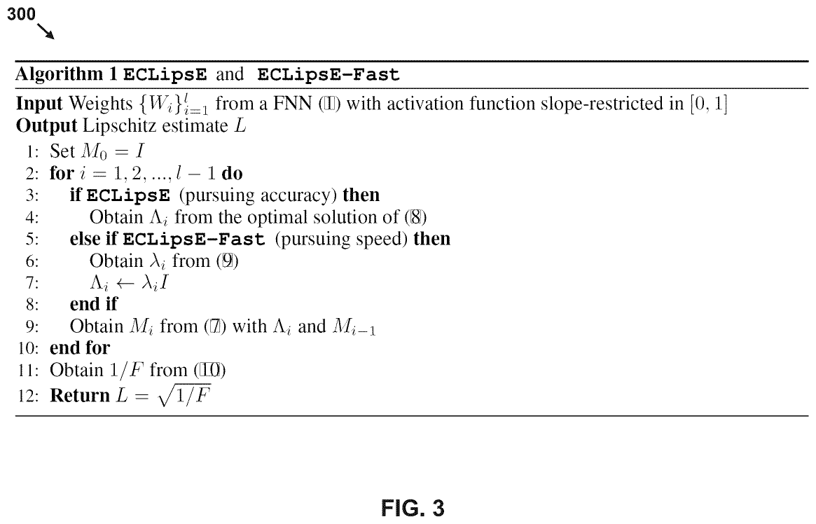

FIG. 3 shows pseudocode 300 for an exemplary implementation of the ECLipsE algorithm and the ECLipsE-Fast algorithm. The first algorithm, the ECLipsE algorithm, explores the geometric features that enable us to provide an accurate Lipschitz estimate by solving small semidefinite programs (SDPs), which are of the size of the weight matrices of each layer. The second algorithm, the ECLipsE-Fast algorithm, relaxes the sub-problems at each stage and yields a closed-form solution for each sub-problem that makes it extremely fast. These algorithms represent different trade-offs between efficiency and accuracy. One may choose the ECLipsE algorithm if pursuing accuracy, and choose the ECLipsE-Fast algorithm for applications where time is of the essence. Thus, the ECLipsE algorithm and the ECLipsE-Fast algorithm are respectively preferable based on whether the priority is accuracy or speed.

We observe in equation (7) that Mᵢ is obtained in a recursive manner and depends on Λᵢ and Mᵢ₋₁, i∈ [symbol] ₗ₋₁. Therefore, we decide Λᵢ and then calculate Mᵢ for i∈ [symbol] ₗ₋₁ sequentially. Thus, these two algorithms can be implemented layer-by-layer in a compositional manner.

Concretely, for the ECLipsE algorithm, we obtain Λᵢ, i∈ [symbol] ₗ₋₁ at each stage i using the information from the next layer, i.e. Wᵢ₊₁, by solving the following small SDP:

$${max}_{{c}_{i}} {c}_{i} s . t . [ \begin{matrix}{Λ}_{i} - {c}_{i} {W}_{i + 1}^{T} {W}_{i + 1} & \frac{1}{2} {{Λ}_{i} ( {{W}_{i} ( {M}_{i - 1} )}^{- 1} {W}_{i}^{T} )}^{\frac{1}{2}} \\ \frac{1}{2} {( {{W}_{i} ( {M}_{i - 1} )}^{- 1} {W}_{i}^{T} )}^{\frac{1}{2}} {Λ}_{i} & I\end{matrix} ] > 0 , \qquad ( 8 )$$

$${Λ}_{i} ∈ {𝔻}_{+} , {c}_{i} > 0$$

Thus, using the ECLipsE algorithm, the processor 110 determines each respective matrix Λᵢ by solving a respective SDP matrix inequality. In each case, the respective SDP matrix inequality depends upon weights Wᵢ₊₁ of a sequentially subsequent hidden neural network layer i+1 in the sequence of hidden neural network layers Lᵢ.

In contrast, for the ECLipsE-Fast algorithm, λᵢI, i∈ [symbol] ₗ₋₁ and Λᵢ is calculated in closed-form as

$${λ}_{i} = \frac{2}{{σ}_{max} ( {{W}_{i} ( {M}_{i - 1} )}^{- 1} {W}_{i}^{T} )} . \qquad ( 9 )$$

Note that this completely eliminates the need to solve matrix inequality SDPs altogether. Thus, using the ECLipsE-Fast algorithm, the processor 110 determines each respective matrix Λᵢ as a multiple of the identity matrix I. Particularly, the processor 110 determines a plurality of scalar values λᵢ. Each of the plurality of scalar values λᵢ corresponds to a respective hidden neural network layer in the sequence of hidden neural network layers Lᵢ, denoted by a subscript i. The processor 110 then determines the plurality of matrices Λᵢ by multiplying the plurality of scalar values λᵢ with the identity matrix I.

The method 200 continues with estimating the Lipschitz constant L based on the plurality of matrices Mᵢ (block 240). Particularly, the processor 110 of the computing device 100 is configured to estimate the Lipschitz constant L based on the plurality of matrices Mᵢ. In particular, the processor 110 estimates the Lipschitz constant L based on the respective matrix Mₗ₋₁ corresponding to the sequentially final hidden neural network layer in the sequence of hidden neural network layers Lᵢ.

At last, after all Λᵢs, i∈ [symbol] ₗ₋₁ are determined, we obtain the smallest 1/F, which yields the smallest Lipschitz estimate L=\vec{1/F}, as follows

$$1 / F = {σ}_{max} ( {W}_{i}^{T} {{W}_{i} ( {M}_{l - 1} )}^{- 1} ) . \qquad ( 10 )$$

Remark 2. We choose to directly calculate the smallest 1/F rather than first derive the largest F. This is because obtaining the largest F first involves taking the inverse of Wₗ^{T}Wₗ, which can cause numerical issues due to the potential singularity of

$${W}_{l}^{T} {W}_{l} .$$

In contrast, directly calculating the smallest 1/F involves taking the inverses of Mₗ₋₁, which is already guaranteed to be strictly positive definite at layer l−1 when deciding Λₗ₋₁.

### Theoretical Foundation

Now we dive into the cascade structure of feed-forward neural networks and demonstrate the theory behind the two algorithms. We analyze the compositional algorithms of FIG. 3 in a backward manner, starting with the output layer. After all Λᵢ, i∈ [symbol] ₗ₋₁ are decided, Mᵢ>0, i∈ [symbol] ₗ₋₂ hold. From Theorem 3, it remains to guarantee that

$${M}_{l - 1} - {FW}_{l}^{T} {W}_{l} > 0$$

and consequently, equation (10), for which we state the following result.

Proposition 1. For given Λᵢ, i∈ [symbol] ₗ₋₁ that satisfies Mᵢ>0, i∈ [symbol] ₗ₋₂, the tightest upper bound for the Lipschitz constant is

$$L = \sqrt{{σ}_{max} ( {W}_{l}^{T} {{W}_{l} ( {M}_{l - 1} )}^{- 1} )} .$$

Now, at stage l−1, when deciding Λₗ₋₁, Λᵢ, i∈ [symbol] ₗ₋₂ are fixed and thus Mₗ₋₂ is fixed. According to Proposition 1, we would like to choose Λₗ₋₁ such that

$${σ}_{max} ( {W}_{l}^{T} {{W}_{l} ( {M}_{l - 1} )}^{- 1} ) ,$$

where Mₗ₋₁ is a function of Λₗ₋₁, is as small as possible. We have the following result.

Lemma 1. If Mᵢ>0, then

$${W}_{i + 1}^{T} {{W}_{i + 1} ( {M}_{i} )}^{- 1}$$

and Wᵢ₊₁(Mᵢ)⁻¹(Wᵢ₊₁)^{T} share the same non-zero eigenvalues.

Note that at stage i, it is guaranteed that Mᵢ>0. In practice, Wᵢ having full row rank is easily satisfied, especially at the last layer where the output layer is much smaller than the last hidden layer. Taking i=l−1, Lemma 1 infers that it is equivalent to minimize

$${σ}_{max} ( {{W}_{l} ( {M}_{l - 1} )}^{- 1} {W}_{l}^{T} )$$

when deciding on Λₗ₋₁. Note that Mₗ₋₁>0, and consequently, the existence of

$${M}_{l - 1}^{- 1}$$

is already guaranteed when we reach the last stage. For the sake of conciseness, we define

$${ℱ}_{i} {=}^{△} {{W}_{i} ( {M}_{i - 1} )}^{- 1} {W}_{i}^{T}$$

i∈ [symbol] ₗ₋₁. From equation (7),

$${M}_{i} = {Λ}_{i} - \frac{1}{4} {Λ}_{i} {ℱ}_{i} {Λ}_{i} .$$

We further write out the recursive expression for [symbol] ᵢ as

$${ℱ}_{i + 1} = {{W}_{i + 1} ( {M}_{i} )}^{- 1} {W}_{i + 1}^{T} = \{ \begin{matrix}{W}_{1} {W}_{1}^{T} & i = 0 \\ {{W}_{i + 1} ( {Λ}_{i} - \frac{1}{4} {Λ}_{i} {ℱ}_{i} {Λ}_{i} )}^{- 1} {W}_{i + 1}^{T} & i ∈ {ℤ}_{l - 1}\end{matrix} . \qquad ( 11 )$$

Lemma 2. For any constant γ∈(0,1), any Λᵢ∈D₊ that satisfied

$${M}_{i} = {Λ}_{i} - \frac{1}{4} {Λ}_{i} {ℱ}_{i} {Λ}_{i} > 0$$

is also a feasible solution for

$${=}^{△} {Λ}_{i} - \frac{1}{4} {Λ}_{i} ( {γℱ}_{i} ) {Λ}_{i} > 0.$$

In other words, the feasible region {Λᵢ: Mᵢ>0, Λᵢ∈ [symbol] ₊}⊆{Λᵢ: [symbol] >0, Λᵢ∈ [symbol] ₊}.

Lemma 2 gives us the observation that a contraction [symbol] ᵢ→γ [symbol] ᵢ, γ∈(0,1) yields a larger feasible space for Λᵢ∈D₊ to ensure Mᵢ>0. Meanwhile, equation (11) shows that for any given Λᵢ, a smaller [symbol] ᵢ leads to a smaller [symbol] ᵢ₊₁ for the next stage. We can characterize how ‘small’ [symbol] ᵢ is by its spectral norm σₘₐₓ( [symbol] ᵢ). Then, minimizing σₘₐₓ( [symbol] ᵢ) aligns with our goal of minimizing

$${σ}_{max} ( {W}_{l}^{T} {{W}_{l} ( {M}_{l - 1} )}^{- 1} ) = {σ}_{max} ( {{W}_{l} ( {M}_{l - 1} )}^{- 1} {W}_{l}^{T} ) = {σ}_{max} ( {ℱ}_{l} )$$

at the last stage. In other words, a smaller [symbol] ₁ at the start will generally translate to a tighter Lipschitz estimate at the output layer if we always choose to minimize the spectral norm σₘₐₓ(Fᵢ) at each stage.

Now we focus on how to specifically optimize Λᵢ, i∈ [symbol] ₗ₋₁. At stage i, the goal is to seek the Λᵢ that minimizes σₘₐₓ( [symbol] ᵢ₊₁), where

$${ℱ}_{i + 1} = {{W}_{i + 1} ( {Λ}_{i} - \frac{1}{4} {Λ}_{i} {ℱ}_{i} {Λ}_{i} )}^{- 1} {W}_{i + 1}^{T}$$

as in equation (11). Note that Mᵢ₋₁ and [symbol] ᵢ are already fixed and can be regarded as constants at the i-th stage.

Proposition 2. If there exists a singular matrix N≥0 such that

$${M}_{i} = {c}_{i} {W}_{i + 1}^{T} {W}_{i + 1} + N ,$$

with constant cᵢ>0, then σₘₐₓ( [symbol] ᵢ₊₁)=1/cᵢ, ∀i∈ [symbol] ₗ₋₁.

In other words, we need to find the largest cᵢ>0 to minimize σₘₐₓ( [symbol] ᵢ₊₁)=1/cᵢ. Recall that

$${M}_{i} = {Λ}_{i} - \frac{1}{4} {Λ}_{i} {ℱ}_{i} {Λ}_{i}$$

is a function of Λᵢ. We state the following proposition, which is used to derive the small sub-problems at each stage.

Proposition 3. Consider the following optimization problem for ∀i∈ [symbol] ₗ₋₁.

$${max}_{{c}_{i}} {c}_{i} s . t . {Λ}_{i} - \frac{1}{4} {Λ}_{i} {{W}_{i} ( {M}_{i - 1} )}^{- 1} {W}_{i}^{T} {Λ}_{i} - {c}_{i} ( {W}_{i + 1}^{T} {W}_{i + 1} ) > 0 > 0 , {Λ}_{i} ∈ {𝔻}_{+} , {c}_{i} > 0 \qquad ( 12 )$$

Then, the optimal value cᵢ is the largest constant such that Mᵢ can be written as

$${M}_{i} = {c}_{i} {W}_{i + 1}^{T} {W}_{i + 1} + N ,$$

where N is some singular matrix such that N≥0. Moreover, the feasible region for the optimization problem is always nonempty.

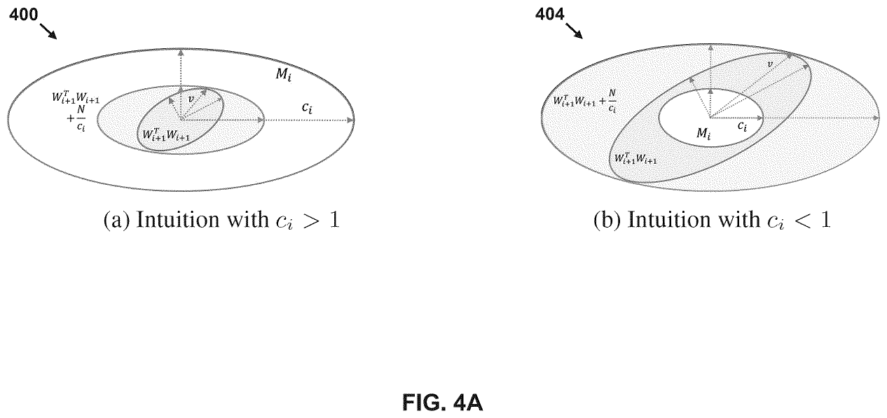

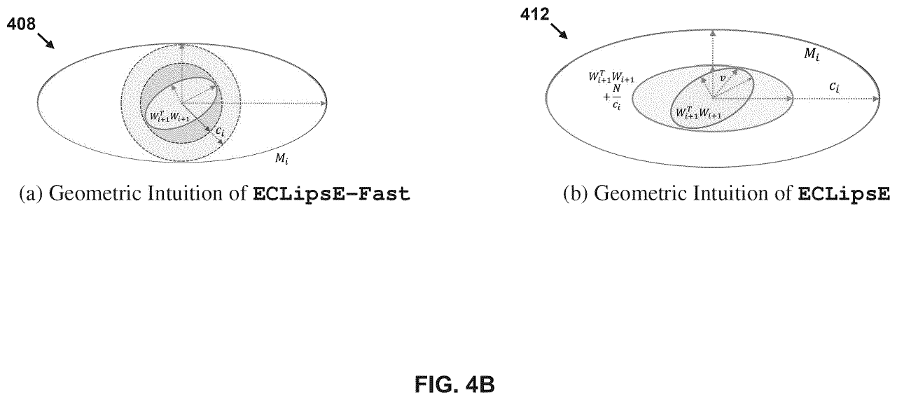

FIG. 4A shows a Geometric Analysis of the ECLipsE algorithm. In particular, the process of achieving the largest cᵢ>0 is illustrated. We geometrically represent a positive semidefinite matrix by the ellipsoid generated by the transformation of a unit ball in the Euclidean space by the matrix. For simplicity of exposition, we refer to this ellipsoid as the ‘shape’ of the matrix. We plot the shapes of Mᵢ and

$${W}_{i + 1}^{T} {W}_{i + 1}$$

in 2D, with different shading. The positive definiteness of the constraint in equation (12) is equivalent to the ellipsoid of

$${W}_{i + 1}^{T} {W}_{i + 1}$$

being contained in the ellipsoid corresponding to Mᵢ/cᵢ. Specifically, illustration (a) of FIG. 4A includes a geometric diagram 400 for when cᵢ>1, which demonstrates the maximum contraction of Mᵢ, corresponding to the largest cᵢ, such that ellipsoid

$${W}_{i + 1}^{T} {W}_{i + 1}$$

is still contained in ellipsoid of cᵢMᵢ. Similarly, illustration (b) of FIG. 4A includes a geometric diagram 404 for when cᵢ<1, which demonstrates the minimum extent (the smallest 1/cᵢ) to which Mᵢ needs to expand, such that the ellipsoid of

$${W}_{i + 1}^{T} {W}_{i + 1}$$

is contained. Algebraically, in both cases, cᵢ is the ratio of the lengths of the arrows. By Proposition 2, the resulting ellipsoid is

$${M}_{i} / {c}_{i} = {W}_{i + 1}^{T} {W}_{i + 1} + N / {c}_{i}$$

for both cases, and is tangent to the ellipsoid of

$${W}_{i + 1}^{T} {W}_{i + 1} .$$

Moreover, the vector pointing from the origin to the tangency point aligns with the direction of eigenvectors (the vector v in the geometric diagrams) corresponding to the zero eigenvalues of the singular matrix N≥0.

Combining Proposition 2 and 3, we can derive an optimization problem to sequentially find the appropriate Λᵢ, i∈ [symbol] ₗ₋₁. The first constraint in equation (12) is quadratic in Λᵢ, which makes it unattractive for practical purposes. Therefore, we apply the Schur Complement to transform it into the linear matrix inequality (LMI) constraint in equation (8). Thus, the optimization problem in Proposition 3 becomes equivalent to the SDP in equation (8), yielding the ECLipsE algorithm. Notice that there are several ways to write the Schur complement of the constraint in equation (12). We choose this specific structure to avoid singularity of the diagonal entries and ensure positive definiteness.

The ECLipsE-Fast algorithm achieves remarkable speed by further reducing Λᵢ, i∈ [symbol] ₗ₋₁ to a multiple of the identity matrix λᵢI, where λᵢ>0, and by relaxing the sub-problems. While our goal remains to minimize

$${σ}_{max} ( {ℱ}_{i + 1} ) = {σ}_{max} ( {{W}_{i + 1} ( {Λ}_{i} - \frac{1}{4} {Λ}_{i} {ℱ}_{i} {Λ}_{i} )}^{- 1} {W}_{i + 1}^{T} ) ,$$

we intentionally disregard information from Wᵢ₊₁, and instead focus solely on minimizing the spectral norm of

$${( {Λ}_{i} - \frac{1}{4} {Λ}_{i} {ℱ}_{i} {Λ}_{i} )}^{- 1} .$$

Roughly speaking, a smaller

$${σ}_{max} ( {( {Λ}_{i} - \frac{1}{4} {Λ}_{i} {ℱ}_{i} {Λ}_{i} )}^{- 1} )$$

yields a smaller σₘₐₓ( [symbol] ᵢ₊₁). This relaxation allows us to derive a closed-form solution for Λᵢ, i∈ [symbol] ₗ₋₁ as follows.

Proposition 4. Choosing

$${λ}_{i} = \frac{2}{{σ}_{max} ( {ℱ}_{1} )} > 0 minimizes {σ}_{max} ( {( {Λ}_{i} - \frac{1}{4} {Λ}_{i} {ℱ}_{i} {Λ}_{i} )}^{- 1} )$$

where Λᵢ=λᵢI under the constraint that

$${M}_{i} = {Λ}_{i} - \frac{1}{4} {Λ}_{i} {ℱ}_{i} {Λ}_{i} > 0.$$

Moreover, this closed-form solution for λᵢ always satisfies Mᵢ>0, i∈ [symbol] ₗ₋₁.

By the definition of [symbol] ᵢ, Proposition 4 matches with equation (9), yielding algorithm the ECLipsE-Fast algorithm. Although this relaxation may result in a loss of tightness, the closed-form solution offers the advantage of significantly increased computational speed.

FIG. 4B shows a comparison between the ECLipsE-Fast algorithm and the ECLipsE algorithm in the case where cᵢ>1. In particular, a geometric analysis behind the development of the ECLipsE-Fast algorithm is illustrated by geometric diagram 408, and compared with the ECLipsE algorithm, illustrated by geometric diagram 412. The key idea behind the ECLipsE-Fast algorithm is that instead of keeping the shape of Mᵢ fixed, and contracting the ellipsoid itself, as in the ECLipsE algorithm, we first find the largest inscribed ball for the ellipsoid of Mᵢ. Then, we contract this ball to the maximum extent such that it still contains

$${W}_{i + 1}^{T} {W}_{i + 1} .$$

The resulting van is precisely the smallest circumscribing ball for the ellipsoid of

$${W}_{i + 1}^{T} {W}_{i + 1} .$$

Note that this approach serves as an approximation for the process of contraction depicted in illustration (b) (corresponding to the ECLipsE algorithm), thus yielding a smaller cᵢ. We use this approximation to achieve a closed-form solution, which significantly increases the computational speed.

Remark 3. In Lemma 2, the analysis initially fixes the shape of [symbol] ᵢ. However, when optimizing Λᵢ, the shape of the feasible region depends on [symbol] ᵢ, which can vary with different Λᵢ₋₁, i∈ [symbol] ₗ. Thus, this approximation, which allows for a scalable distributed algorithm to solve the centralized problem equation (3), introduces an unavoidable but minor tradeoff in achieving global optimality.

### Experimental Results

To better illustrate the advantages of the ECLipsE algorithm and the ECLipsE-Fast algorithm, experimental results are discussed here. Particularly, we employed the ECLipsE algorithm and the ECLipsE-Fast algorithm on randomly generated neural networks and on neural networks trained on the MNIST (Modified National Institute of Standards and Technology) dataset. Here, we demonstrate that our approach provides a steep reduction in computation time (as much as several thousand times faster, depending on the algorithm for deeper networks) while yielding Lipschitz bounds that are very close to or even better than those achieved by state-of-the-art approaches in a broad range of experiments.

Baselines. For the ECLipsE algorithm, Λᵢ, i∈ [symbol] ₗ₋₁ can have different diagonal entries, which benchmarks to LipSDP-Neuron. For the ECLipsE-Fast algorithm, Λᵢ=λᵢI, i∈ [symbol] ₗ₋₁, which benchmarks to LipSDP-Layer. Additionally, we compare our Lipschitz estimates to the naive upper bound

$${L}_{naive} = {Π}_{i = 1}^{l} {‖ {W}_{i} ‖}_{2} ,$$

### of CPLip and LipDiff.

Randomly Generated Neural Networks. We set the input dimension to be 4 and the output dimension to be 1. The activation functions are chosen to be ReLU, and the number of neurons in each hidden layer is set to be the same. We randomly generate weights for each layer to follow the normal distribution. Also, in order to avoid the case where the Lipschitz constant is too large or too small and may cause numerical issues, we scale the weights on each layer such that the norm is randomly chosen in [0.4, 1.8], following a uniform distribution.

We first consider randomly generated networks, where the number of layers is chosen from {2, 5, 10, 20, 30, 50, 75, 100}, and the number of neurons is chosen from {20, 40, 60, 80, 100}, amounting to a total of 40 experiments for each algorithm (including the baselines). We quantify the computation time and tightness of the Lipschitz bounds. The Lipschitz bounds presented in the following figures are normalized to the trivial upper bound for ease of comparison.

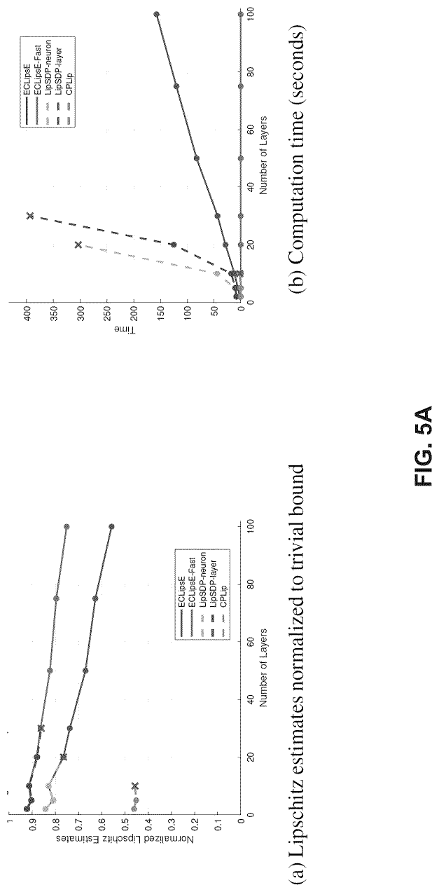

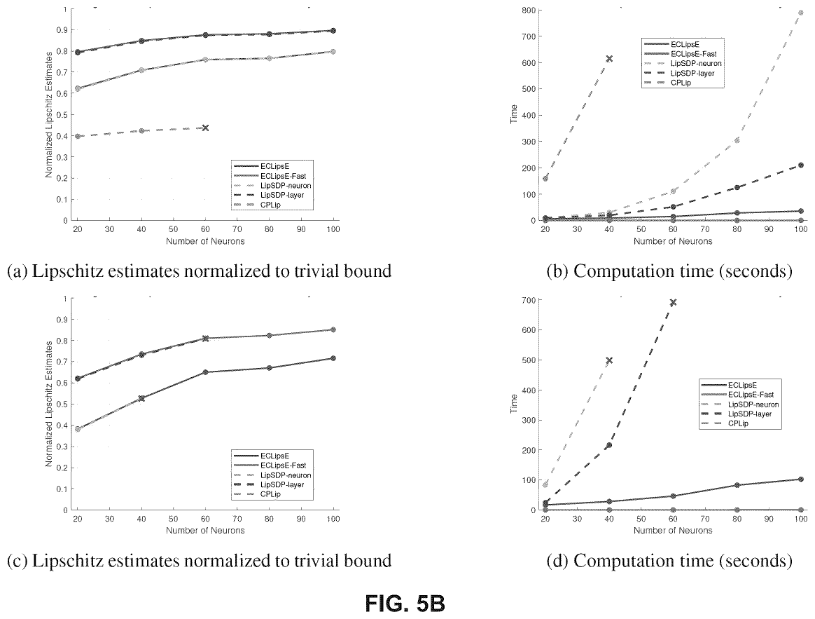

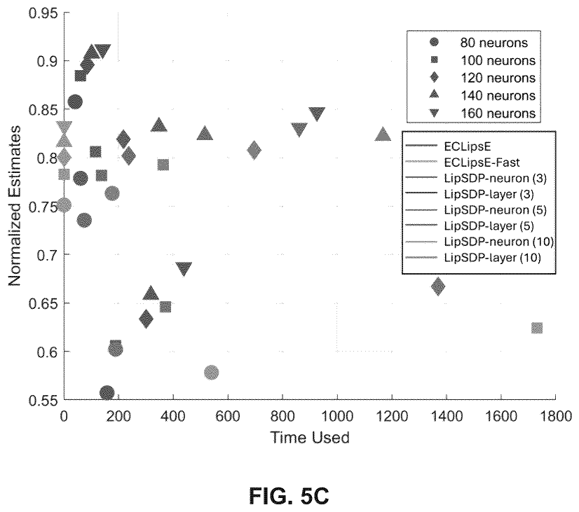

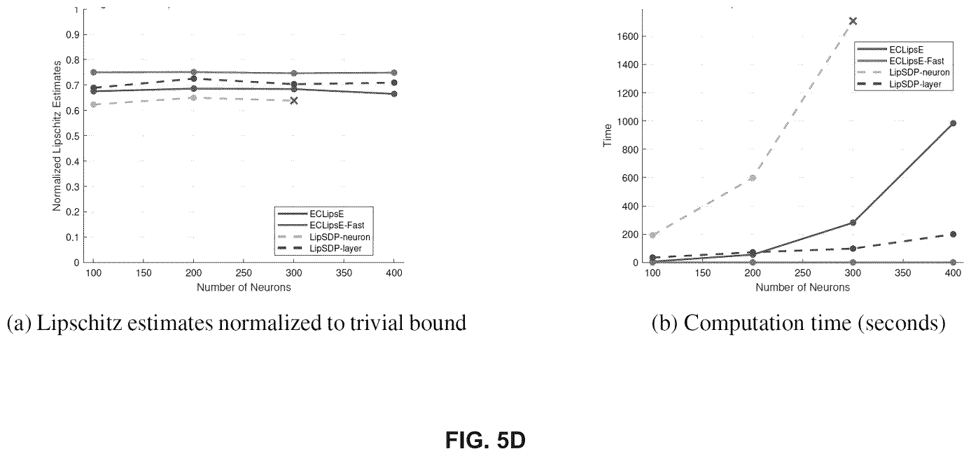

FIG. 5A shows a performance of the ECLipsE-Fast algorithm and the ECLipsE algorithm for a randomly generated network with increasing network depth, with respect to baselines. In the experiments, the randomly generated network had 80 neurons per layer. The x markings indicate that the algorithm fails to provide an estimate within the computational cutoff time beyond this network size.

Case 1: Varying network depth (number of layers). We select a network with 80 neurons per layer, and demonstrate the scalability of our algorithm as network depth increases. Note that all baseline approaches fail to provide a Lipschitz estimate within a computational cutoff time of 15 minutes for networks larger than this size. As the number of layers increases, the computation time for the CPLip algorithm explodes (the algorithm does not return a Lipschitz estimate within the cutoff time beyond 20 layers); however, CPLip provides the most accurate estimates in smaller networks. LipDiff provides inadmissible Lipschitz estimates even for moderate networks, returning as much as 10-100 times the trivial bound. Also, while LipDiff has similar computational time for smaller networks, the computational time grows for deeper networks. Consequently, we do not include these results in the plots. LipSDP-Neuron and LipSDP-Layer are also scalable to some extent; however, they fail for a network of 30 and 50 layers, respectively. In contrast, the computation time for the ECLipsE algorithm and the ECLipsE-Fast algorithm stays low and grows only linearly with respect to the number of layers (illustration (b) of FIG. 5A). Notably, the ECLipsE-Fast algorithm is significantly faster (thousands of times) than LipSDP-Layer, owing to the closed-form solution at each stage, while the ECLipsE algorithm is also considerably faster than LipSDP-Neuron. The Lipschitz estimates given by the ECLipsE algorithm and the ECLipsE-Fast algorithm are very close to the ones from LipSDP-Neuron and LipSDP-Layer, respectively (illustration (a) of FIG. 5A), and outperform the trivial bound. As the number of layers increases, the normalized Lipschitz estimates are smaller, indicating that our algorithms are well-suited to very deep networks.

FIG. 5B shows a performance of the ECLipsE-Fast algorithm and the ECLipsE algorithm for randomly generated networks with increasing network width, with respect to baselines. In the experiments, the randomly generated networks had 20 layers (illustrations (a) and (b)) and 50 layers ((c) and (d)). The x markings indicate that the algorithms fail to provide an estimate within the computational cutoff time of 15 minutes beyond this network size.

Case 2: Varying neural network width (number of neurons per layer). We now examine the performance of our algorithms for wider (more hidden neurons per layer), rather than deeper networks (with more layers), and demonstrate the results for networks with 20 and 50 layers respectively (FIG. 5B). While the complete raw data is presented in Appendix E, we discuss the results for 20 and 50 layer networks here, since they represent the network sizes where different baselines fail to return Lipschitz estimates beyond the computation cutoff time of 15 min. Note that while LipDiff also manages to generate estimates for all network sizes in our 50 layers case, it once again provides inadmissible Lipschitz constants, returning as much as 104-106 times the trivial bound. Therefore, we do not include these results in FIG. 5B. We can observe from illustrations (b) and (d) of FIG. 5B, that the computation time needed for CPLip, LipSDP-Layer, and LipSDP-Neuron significantly increases with the number of neurons, while the computation time of our method still grows linearly. Meanwhile, the Lipschitz estimates from the ECLipsE algorithm and the ECLipsE-Fast algorithm are close to the ones from LipSDP-Neuron and LipSDP-Layer, respectively (illustrations (a) and (c) of FIG. 5B). Thus, we can conclude that our method significantly improves scalability for wider neural networks.

FIG. 5C shows computation time vs estimation accuracy for the ECLipsE algorithm, the ECLipsE-Fast algorithm, and LipSDP splitting with different sub-network sizes.

Case 3: Comparison with LipSDP implementations. In order to address the scalability issue as the size of the network grows, LipSDP utilizes a splitting approach, where the network is split into smaller sub-networks and the Lipschitz constants for each sub-network are composed at the end to obtain the final estimate. We benchmark our approach with respect to the performance of LipSDP-Layer and LipSDP-Neuron, considering different sub-network sizes. Note that our algorithms do not require any splitting, since they remain scalable to large networks. As the feed-forward neural networks are larger than the ones in previous cases, we change the cutoff time to 30 minutes. We conduct two sets of experiments to study how our algorithms perform on considerably deep neural networks and how network width affects these results.

In the first set of experiments, we considered a feed-forward neural network 122 with 100 layers, with the number of neurons chosen from the set {80, 100, 120, 140, 160}. The splitting sizes for LipSDP-Neuron and LipSDP-Layer are 3, 5, and 10. We represent different feed-forward neural network sizes by shapes and different algorithms by the shading in FIG. 5C. By plotting the normalized Lipschitz estimates and computation times on the two axes, we illustrate how efficient and accurate an algorithm is by how close the corresponding data point is to the origin. We observe that all the data points for the ECLipsE-Fast algorithm are at the leftmost extreme of the plot, indicating that it is the most efficient algorithm. Further, the ECLipsE-Fast algorithm also outperforms the cluster corresponding to LipSDP-layer (with the network split into 3) in both tightness and speed. Comparing data points of the same shape, the ECLipsE-Fast algorithm outperforms LipSDP-Layer for all sub-network splits, both in terms of the Lipschitz estimate and the computation time. Finally, the data points corresponding to the ECLipsE algorithm are clustered at the bottom left, demonstrating that it is relatively more accurate and efficient than all LipSDP methods, no matter how the network is split.

In the second set of experiments, we explored even wider networks. Specifically, we choose a fairly deep neural network with 50 layers and vary the width from 150 to 1000. The splitting size for LipSDP-Neuron and LipSDP-Layer is 5. From these results, we observe that the ECLipsE-Fast algorithm is extremely fast even for very wide networks, with a running time of only 15.63 seconds for a network width of 1000, while the computation time for LipSDP-Layer grows significantly. Also, while the ECLipsE algorithm fails when the width reaches 400, it is comparable to LipSDP-Neuron split into 5 sub-networks in terms of time performance.

Remark 4. We notice that when the neural networks are significantly wide, the ECLipsE algorithm takes more than 30 minutes, while the ECLipsE-Fast algorithm remains efficient. This observation can be explained by examining the computational complexity of these algorithms. Suppose a neural network has n hidden layers with m neurons. Then, the computational costs for LipSDP and the ECLipsE algorithm are O(n⁴m⁴) and O(nm⁴) respectively. We can observe that the complexity is significantly decreased in terms of the depth, but is the same in terms of the width, immediately indicating the advantage for deep networks. Nevertheless, as m grows, the difference between (n⁴m⁴) and O(nm⁴) is still drastically enhanced, especially with large n. More importantly, for the ECLipsE-Fast algorithm, the computational cost drops to O(nm³). This is the fastest one can expect if the weights on each layer are treated as a whole.

Neural Networks Trained on MNIST. For training on the dataset MNIST, the input dimension is 584 and the output dimension is 10, which is compatible with the dataset. The activation functions are chosen to be ReLU, and the number of neurons in each hidden layer is set to be the same. We train neural networks using the SGD optimizer with a learning rate of 0.01 and momentum of 0.9 until they achieve at least 97% accuracy on test data.

FIG. 5D shows a performance of the ECLipsE-Fast algorithm and the ECLipsE algorithm for a 3-layer network trained on MNIST, with respect to baselines for an increasing number of neurons. The x markings indicate that the algorithm fails to provide an estimate within the computational cutoff time beyond this network size.

We now demonstrate our algorithms on four networks trained on the MNIST dataset to achieve an accuracy of at least 97%. The resulting networks are not very deep (3 layers), with 100, 200, 300, and 400 neurons. We set a computational cutoff time of 30 min to obtain Lipschitz estimates. As described in the note on Baselines earlier in this section, the ECLipsE algorithm is benchmarked against LipSDP-Neuron, and the ECLipsE-Fast algorithm is benchmarked against the faster LipSDP-Layer due to their mathematical structure. From illustration (b) of FIG. 5D, we can see that the ECLipsE-Fast algorithm is significantly faster than LipSDP-Layer, while the ECLipsE algorithm is also considerably faster than LipSDP-Neuron. Note that all algorithms provide very similar Lipschitz estimates (illustration (a) of FIG. 5D). Therefore, for networks that are not very deep, such as those in this example, the ECLipsE-Fast algorithm is the optimal choice, since it significantly outperforms all algorithms in terms of speed, while the approximation error due to the closed-form solution is not too significant compared to the baselines.

### Exemplary Applications

Exemplary applications of the method 200 are introduced here. However, it should be appreciated that the method 200 can be advantageously applied to any application in which fast and accurate estimation of a Lipschitz constant for a feed-forward neural network is desired.

In a first exemplary application, a Lipschitz constant is estimated for the practical purpose of certifying the robustness of a feed-forward neural network. It will be appreciated that certificates of robustness are useful, and in many cases necessary, in a variety of applications in which a neural network is used. For example, certifiable robustness against adversarial attacks is a key feature for neural networks used in certain security applications (e.g., malware protection). Similarly, certifiable robustness against sensor noise or environmental noise is important for safety purposes in many autonomous systems that incorporate neural networks (e.g., autonomous driving systems or robotics systems). Finally, certifiable robustness of a neural network may be necessary to satisfy regulatory requirements or other legal requirements in certain applications.

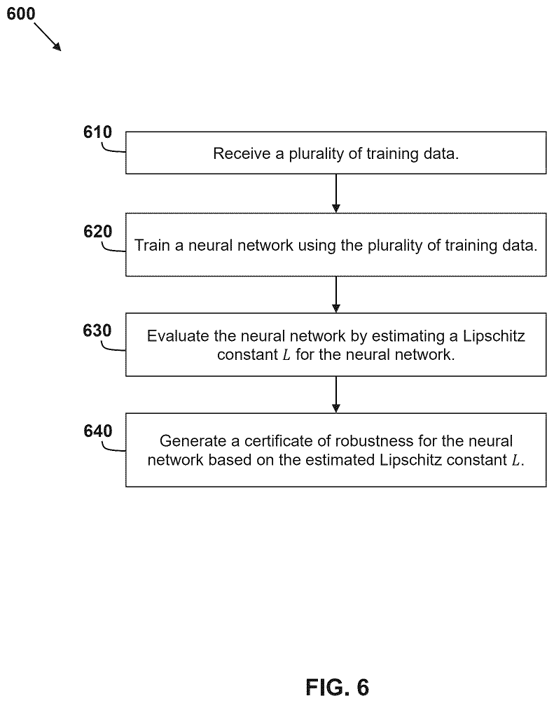

FIG. 6 shows a flow diagram for a method 600 for certifying the robustness of a feed-forward neural network. The method 600 advantageously leverages the method 200 for estimating the Lipschitz constant very quickly and with high accuracy. The Lipschitz constant is advantageously used to certify the robustness of the feed-forward neural network, enabling it to be deployed in applications that require robustness certification.

The method 600 begins with receiving a plurality of training data (block 610). Particularly, the processor 110 receives a plurality of training data. In some embodiments, the plurality of training data includes a plurality of individual pairs of labeled input and output data. However, in the case of unsupervised learning, the plurality of training data may simply include a plurality of input data.

Next, the method 600 continues with training a neural network using the plurality of training data (block 620). Particularly, the processor 110 trains the feed-forward neural network 122 using the received training data. To this end, the processor 110 may utilize any algorithm in the art of machine learning for training a neural network model, including gradient descent, Newton's method, etc. In general, the processor 110 inputs the training data into the feed-forward neural network 122, either in batches or as individual training samples, and evaluates an error in the output of the feed-forward neural network 122 using a loss function. The error is propagated through the feed-forward neural network 122 to update the weights in each layer. This process is repeated until satisfactory performance is achieved by the feed-forward neural network 122.

The method 600 continues with evaluating the neural network by estimating a Lipschitz constant L for the neural network (block 630). Particularly, the processor 110 evaluates the feed-forward neural network 122 by estimating the Lipschitz constant L for the feed-forward neural network 122. The processor 110 estimates the Lipschitz constant L using the ECLipsE-Fast algorithm or the ECLipsE algorithm, which were discussed in detail above.

The method 600 continues with generating a certificate of robustness for the neural network based on the estimated Lipschitz constant L (block 640). Particularly, the processor 110 generates a robustness certificate for the feed-forward neural network 122 based on the Lipschitz constant L. It should be appreciated that a robustness certificate is a formal guarantee that the output of the feed-forward neural network 122 will remain consistent (e.g., change within defined range that is considered reasonable or negligeable) under a defined set of perturbations to the input. In one embodiment, the robustness certificate is in the form of a Lipschitz certificate that certifies that perturbations below a maximum perturbation size cannot change an output classification of the feed-forward neural network 122.

In some embodiments, in response to the Lipschitz constant L being less than or equal to a predetermined threshold, the processor 110 issues the Lipschitz certificate for the feed-forward neural network 122. Alternatively, in some embodiments, the processor 110 computes a maximum input perturbation size (e.g., a certified radius) based on the Lipschitz constant L. In response to the maximum perturbation size being less than or equal to a desired perturbation threshold, the processor 110 issues the Lipschitz certificate for the feed-forward neural network 122.

In a second exemplary application, a Lipschitz constant is estimated for the practical purpose of ensuring the consistency and robustness of a feed-forward neural network that is updated in deployment. Particularly, in applications that leverage online training processes to constantly update a feed-forward neural network, estimation of the Lipschitz constant can be advantageously used to ensure that the outputs of the feed-forward neural network remain stable and robust.

A wide variety of applications that incorporate online training can advantageously leverage Lipschitz constant estimation for consistency and robustness guarantees. Such systems might include personalized recommendation systems, financial trading systems, conversational AI systems, healthcare systems, and the like. However, the ECLipsE algorithm and the ECLipsE-Fast algorithm are particularly advantageous in applications in which rapid estimation of the Lipschitz constant is key to the successful operation of the system. One example of such a system is an autonomous system (e.g., an autonomous driving or robotic system) in which a feed-forward neural network is used for real-time or near real-time decision making, or in which resource constraints otherwise make other solutions for estimating the Lipschitz constant impractical.

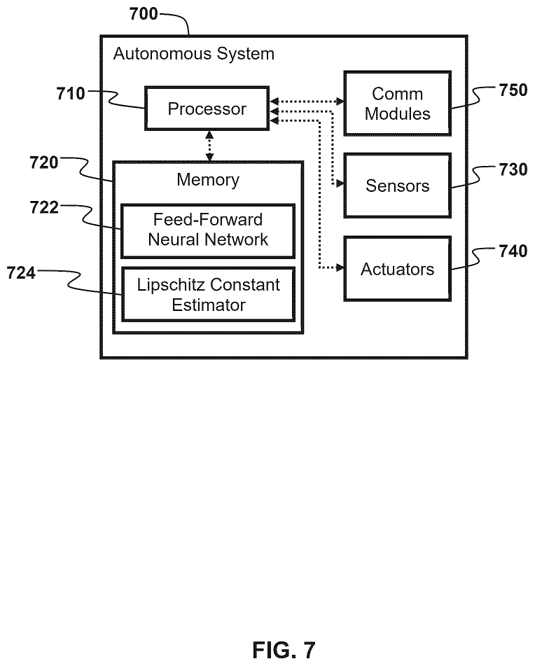

FIG. 7 shows an exemplary embodiment of the autonomous system 700 that leverages a feed-forward neural network to perform one or more tasks. The autonomous system 700 comprises a processor 710, a memory 720, sensors 730, actuators 740, and at least one network communications module 750. The autonomous system 700 may, for example, comprise an autonomous driving system of an autonomous vehicle, or a mobile or stationary robotics system.

The processor 710 is configured to execute instructions to operate the autonomous system 700 to enable the features, functionality, characteristics, and/or the like as described herein. To this end, the processor 710 is operably connected to the memory 720, the sensors 730, the actuators 740, and the network communications module 750. The processor 710 generally comprises one or more processors that may operate in parallel or otherwise in concert with one another. It will be recognized by those of ordinary skill in the art that a “processor” includes any hardware system, hardware mechanism, or hardware component that processes data, signals, or other information. Accordingly, the processor 710 may include a system with a central processing unit, graphics processing units, multiple processing units, dedicated circuitry for achieving functionality, programmable logic, or other processing systems.

The memory 720 is configured to store data and program instructions that, when executed by the processor 710, enable the autonomous system 700 to perform various operations described herein. The memory 720 may be of any type of device capable of storing information accessible by the processor 710, such as a memory card, ROM, RAM, hard drives, discs, flash memory, or any of various other computer-readable medium serving as data storage devices, as will be recognized by those of ordinary skill in the art.

The sensors 730 may comprise a variety of different sensors. In some embodiments, the sensors 730 at least include one or more cameras configured to capture a plurality of images of the environment as the autonomous system 700 navigates through the environment or otherwise operates in the environment. Additionally, in some embodiments, the sensors 730 include sensors configured to measure one or more accelerations, rotational rates, and/or orientations of the autonomous system 700. Finally, in some embodiments, the sensors 730 include a LIDAR sensor or any other time-of-flight or structured light-based sensor, configured to emit measurement light and receive the measurement light after it has reflected throughout the environment.

The actuators 740 may comprise a variety of different actuators necessary for autonomously performing a task in an environment. In some embodiments, the actuators 740 may include motors or steering systems of a locomotion system that, for example, drive and steer a set of wheels to cause the autonomous system 700 to move throughout the environment to perform a task. Additionally, in some embodiments, the actuators 740 may include motors for operating robotic arms or other physical components of the autonomous system 700. It should be appreciated that the particular actuators 740 included in the autonomous system 700 depend on the particular application and the particular tasks to be performed by the autonomous system 700.

The network communications module 750 may comprise one or more transceivers, modems, processors, memories, oscillators, antennas, or other hardware conventionally included in a communications module to enable communications with various other devices. Particularly, the network communications module 750 generally includes an Ethernet adaptor or a Wi-Fi® module configured to enable communication with a wired or wireless network and/or router (not shown) configured to enable communication with various other devices. Additionally, the network communications module 750 may include a Bluetooth® module (not shown), as well as one or more cellular modems configured to communicate with wireless telephony networks.

In at least some embodiments, the memory 720 stores program instructions of a feed-forward neural network 722 that, once trained, is configured to process input data to generate one or more outputs. Additionally, in at least some embodiments, the memory 720 stores program instructions of a Lipschitz constant estimator 724 that is executed to estimate the Lipschitz constant for the feed-forward neural network 722 after it has been trained, retrained, or updated.

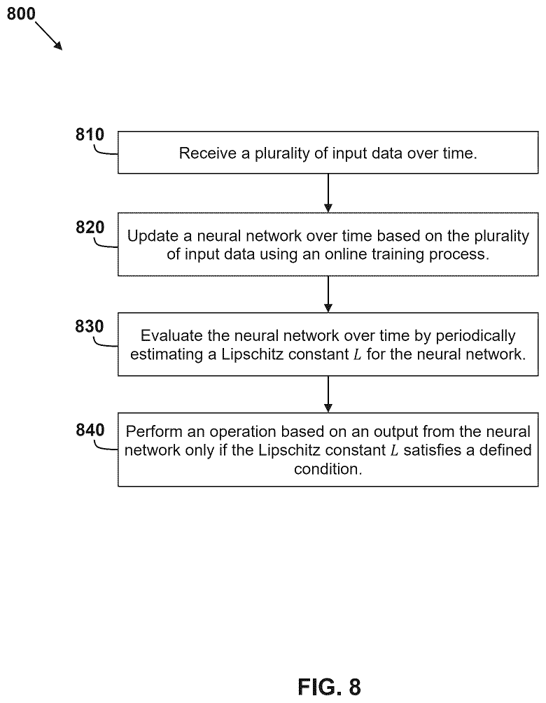

FIG. 8 shows a flow diagram for a method 800 for operating an autonomous system. The method 800 advantageously leverages the method 200 for estimating the Lipschitz constant for a feed-forward neural network very quickly and with high accuracy. The Lipschitz constant is advantageously used to verify that the feed-forward neural network remains stable and robust after the feed-forward neural network is updated using an online training process.

The method 800 begins with receiving a plurality of input data over time (block 810). Particularly, during operation of the autonomous system 700, the processor 710 continuously receives a plurality of input data over time. In at least some embodiments, the processor 710 operates the sensors 730 to continuously collect sensor data that is processed by the feed-forward neural network 722 for the purpose of performing a task in an environment.

Next, the method 800 continues with updating a neural network over time based on the plurality of input data using an online training process (block 820). Particularly, the processor 710 periodically or continuously updates the feed-forward neural network 722 using the received input data using an online training process. It should be appreciated that online training differs from traditional offline or batch training. Particularly, online training seeks to continuously adapt the feed-forward neural network 722 to changing environments or circumstances to detect new patterns in the input data. However, as mentioned previously, online learning presents challenges with respect to verifying the continued consistency and robustness of the feed-forward neural network 722.

To this end, the processor 710 may utilize any algorithm in the art of machine learning for online training of a neural network model, including gradient descent, Newton's method, etc. In general, the processor 710 inputs the training data into the feed-forward neural network 722, either in very small batches or as individual input samples, and evaluates an error in the output of the feed-forward neural network 722 using a loss function. The error is propagated through the feed-forward neural network 722 to incrementally update the weights of the feed-forward neural network 722.

The method 800 continues with evaluating the neural network over time by periodically estimating a Lipschitz constant L for the neural network (block 830). Particularly, the processor 710 evaluates the feed-forward neural network 722 by estimating the Lipschitz constant L for the feed-forward neural network 722. The processor 710 estimates the Lipschitz constant L using the ECLipsE-Fast algorithm or the ECLipsE algorithm, which were discussed in detail above. The processor 710 estimates the Lipschitz constant L on a continuous or periodic basis, for example, after each update to the feed-forward neural network 722.

The method 800 continues with performing an operation based on an output from the neural network only if the Lipschitz constant L satisfies a defined condition (block 840). Particularly, the processor 710 performs an operation based on an output from the feed-forward neural network 722, depending on whether or not the most recently estimated Lipschitz constant L satisfies one or more dynamically defined or predefined conditions. Particularly, in some embodiments, the autonomous system 700 is configured to utilize outputs from the feed-forward neural network 722 to aid in the performance of a variety of tasks and, in particular, uses the outputs to aid in the decision-making and control necessary to perform the task autonomously.

However, because the feed-forward neural network 722 is being continuously updated, it is advantageous for the autonomous system 700 to only use the outputs from the feed-forward neural network 722 if the consistency and robustness of the feed-forward neural network 722 can be guaranteed. In this manner, estimating the Lipschitz constant L helps to keep the risk involved with using the outputs from the feed-forward neural network 722 within an acceptable range by formally characterizing the worst-case scenario.

In the example in which the autonomous system 700 is an autonomous driving system of an autonomous vehicle, the feed-forward neural network 722 may receive images or other sensor data collected of the environment. Based on the images or other sensor data, the feed-forward neural network 722 generates a variety of outputs, for example inferences about a state of the environment (e.g., positions or speeds of objects or other vehicles in the environment). The autonomous driving system makes decisions (e.g., is it safe to change lanes?) and controls actuators 740 thereof to perform autonomous driving maneuvers (e.g., changing lanes) based on the outputs from the feed-forward neural network 722. By evaluating consistency and robustness of the feed-forward neural network 722, the safety and performance of the autonomous vehicle is improved.

In one embodiment, in response to a most recently estimated Lipschitz constant L being less than a predetermined threshold value, the processor 710 performs an operation based on an output from the feed-forward neural network 722. Conversely, in one embodiment, in response to the most recently estimated Lipschitz constant L being greater than the predetermined threshold value, the processor 710 prevents the autonomous system 700 from performing the operation based on the output from the feed-forward neural network 722, or otherwise does not itself perform the operation.

Alternatively, in some embodiments, the processor 710 computes a maximum input perturbation size (e.g., a certified radius) based on the Lipschitz constant L. In response to the maximum perturbation size being less than a desired perturbation threshold, the processor 710 performs an operation based on an output from the feed-forward neural network 722. Conversely, in response to the maximum perturbation size being greater than the desired perturbation threshold, the processor 710 prevents the autonomous system 700 from performing the operation based on the output from the feed-forward neural network 722, or otherwise does not itself perform the operation.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for characterizing a robustness of a neural network, the method comprising:
estimating, with a processor, a Lipschitz constant for the neural network, the Lipschitz constant being estimated by:
forming a first matrix inequality for the neural network;
decomposing the first matrix inequality into a plurality of second matrix inequalities;
determining a plurality of first matrices based on the plurality of second matrix inequalities; and
estimating the Lipschitz constant based on the plurality of first matrices.

2. The method according to claim 1, wherein the neural network is a feed-forward neural network.

3. The method according to claim 1 further comprising:
prior to the estimating the Lipschitz constant, training, with the processor, the neural network using a plurality of training data.

4. The method according to claim 1 further comprising:
after the estimating the Lipschitz constant, generating, with the processor, a robustness certificate for the neural network in response to the Lipschitz constant satisfying a defined condition.

5. The method according to claim 1 further comprising, prior to the estimating the Lipschitz constant:
receiving, with the processor, a plurality of input data over time; and
updating, with the processor, the neural network over time based on the plurality of input data using an online training process,
wherein the estimating the Lipschitz constant is performed periodically over time.

6. The method according to claim 5 further comprising:
after the estimating the Lipschitz constant, operating, with the processor, in response to the Lipschitz constant satisfying a defined condition, a system to perform an operation based on an output from the neural network.

7. The method according to claim 5 further comprising:
after the estimating the Lipschitz constant, preventing, with the processor, in response to the Lipschitz constant not satisfying a defined condition, a system from performing an operation based on an output from the neural network.

8. The method according to claim 1, the forming the first matrix inequality further comprising:
forming the first matrix inequality based on an architecture of the neural network.

9. The method according to claim 1, the decomposing the first matrix inequality further comprising:
decomposing the first matrix inequality into the plurality of second matrix inequalities using a Cholesky decomposition process.

10. The method according to claim 1, wherein:
the neural network includes a sequence of hidden neural network layers; and
each respective first matrix in the plurality of first matrices corresponds to a respective hidden neural network layer in the sequence of hidden neural network layers.

11. The method according to claim 10, the determining the plurality of first matrices further comprising:
determining the respective first matrix of the plurality of first matrices corresponding to a sequentially first hidden neural network layer in the sequence of hidden neural network layers based on an identity matrix; and
determining each respective first matrix, other than the respective first matrix corresponding to the sequentially first hidden neural network layer, based on the respective first matrix corresponding to a sequentially previous hidden neural network layer in the sequence of hidden neural network layers.

12. The method according to claim 11, the determining the plurality of first matrices further comprising:
determining a plurality of second matrices, each respective second matrix in the plurality of second matrices corresponding to a respective hidden neural network layer in the sequence of hidden neural network layers; and
determining each respective first matrix, other than the respective first matrix corresponding to the sequentially first hidden neural network layer, based on the respective second matrix corresponding to the respective hidden neural network layer in the sequence of hidden neural network layers.

13. The method according to claim 12, the determining the plurality of second matrices further comprising:
determining each respective second matrix in the plurality of second matrices by solving a respective semidefinite program matrix inequality.

14. The method according to claim 13, wherein each respective semidefinite program matrix inequality depends upon weights of a sequentially subsequent hidden neural network layer in the sequence of hidden neural network layers.

15. The method according to claim 12, the determining the plurality of second matrices further comprising:
determining each respective second matrix in the plurality of second matrices as a multiple of the identity matrix.

16. The method according to claim 15, the determining the plurality of second matrices further comprising:
determining a plurality of scalar values, each respective scalar value in the plurality of scalar values corresponding to a respective hidden neural network layer in the sequence of hidden neural network layers; and
determining the plurality of second matrices by multiplying the plurality of scalar values with the identity matrix.

17. The method according to claim 10, the estimating the Lipschitz constant further comprising:
estimating the Lipschitz constant based on the respective first matrix in the plurality of first matrices corresponding to a sequentially final hidden neural network layer in the sequence of hidden neural network layers.

18. A method for certifying a robustness of a neural network, the method comprising:
training, with a processor, the neural network using a plurality of training data;
evaluating, with the processor, the neural network by estimating a Lipschitz constant for the neural network, the Lipschitz constant being estimated by:
forming a first matrix inequality for the neural network;
decomposing the first matrix inequality into a plurality of second matrix inequalities;
determining a plurality of first matrices based on the plurality of second matrix inequalities; and
estimating the Lipschitz constant based on the plurality of first matrices; and
generating, with the processor, a robustness certificate for the neural network in response to the Lipschitz constant satisfying a defined condition.

19. A method for operating a system that incorporates a neural network, the method comprising:
receiving, with a processor, a plurality of input data over time;
updating, with the processor, the neural network over time based on the plurality of input data using an online training process;
evaluating, with the processor, the neural network over time by periodically estimating a Lipschitz constant for the neural network, the Lipschitz constant being estimated by:
forming a first matrix inequality for the neural network;
decomposing the first matrix inequality into a plurality of second matrix inequalities;
determining a plurality of first matrices based on the plurality of second matrix inequalities; and
estimating the Lipschitz constant based on the plurality of first matrices; and
operating, with the processor, in response to the Lipschitz constant satisfying a defined condition, the system to perform an operation based on an output from the neural network.

20. The method according to claim 19 further comprising:
preventing, with the processor, in response to the Lipschitz constant not satisfying the defined condition, the system from performing the operation based on the output from the neural network.
